(19) United States
(12) Patent Application Publication
(10) Pub. No.: US 2015/0065927 A1
(43) Pub. Date: Mar. 5, 2015

(54) BRUSH WITH MULTI-HEIGHT BRISTLES

(71) Applicant: L'OREAL, Paris (FR)

(72) Inventors: Gerald Keith Brewer, Redmond, WA (US); Robert Walton, Morristown, TN (US)

(73) Assignee: L'OREAL, Paris (FR)

(21) Appl. No.: 14/462,468

(22) Filed: Aug. 18, 2014

Related U.S. Application Data
(63) Continuation-in-part of application No. 14/014,138, filed on Aug. 29, 2013, now abandoned.

(51) Int. Cl. A61H 7/00

(52) U.S. Cl. CPC A61H 7/005
USPC 601/95

(57) ABSTRACT

The brush includes a plurality of bristles arranged in one or more tufts. The bristles of each tuft have different bristle heights. The bristles 24 can be configured and arranged as bristle pairs, each bristle pair formed by a single filament asymmetrically anchored to a brush head. The brush is suitable for use with a personal care appliance. In one suitable use, the brush can be rotated or oscillated over a patient's skin and/or hair by the personal care appliance in order for the bristles of the tufts to clean, massage, exfoliate, apply shaving cream or gel, etc., a subject's skin or to apply shaving cream or gel.

### CROSS-REFERENCE TO RELATED APPLICATION

This application is a continuation-in-part of U.S. patent application Ser. No. 14/014138, filed Aug. 29, 2013, the disclosure of which is incorporated by reference herein.

### BACKGROUND

Brushes are used in many applications for seemingly countless tasks. In some instances, brushes are designed for specific applications, such as toothbrushes for dental hygiene, powered skin care brushes for cleansing of the facial region, etc. Other brushes have more generic uses, such as a typical scrub brush. Brushes typically utilize a multiplicity of bristles bunched together to form a tuft. Each tuft is anchored in a tuft hole or recess located in the brush head. Typically, numerous tufts/tuft holes are located on the brush head and the number and locations vary depending upon the design.

Power skin care brushes are typically driven directly, such as by a drive shaft or shafts, gears, and a motor. The skin brush typically includes a single brush head, with a plurality of bristle/filament tufts, which move in unison. Some brush heads rotate 360 degrees in one direction continuously, while others oscillate through a selected angle. The higher frequency skin brushes are often referred to as sonic or sonic frequency brushes, the frequency range of such brushes being about 120-300 Hz for smaller brushes and can extend downward to around 40 Hz for larger brushes.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with aspects of the present disclosure, a method is provided for treating skin and/or hair of a subject with a handheld appliance. The method includes oscillating, via a motorized drive system of the handheld appliance, a brush having a plurality of tufts each tuft comprising a plurality of first bristles extending to a first height and a plurality of second bristles extending to a second, greater height, moving the brush into contact with the skin and/or hair of the subject; and thereafter moving the oscillating brush over the skin and/or hair of the subject.

Some disclosed embodiments of the method also includes increasing the amplitude of the oscillating brush by loading the brush via one of contact between the first and second bristles and the skin of the subject and contact between the second bristles and the skin of the subject.

Some disclosed embodiments of the method utilize second bristles having tapered ends and first bristles having end configurations selected from the group consisting of flat, rounded, domed, semi-domed, and tapered.

In some disclosed embodiments of the method, each tufts comprises a plurality of extended filaments each including a first leg and a second leg, wherein the first legs of the extended filaments include the first bristles and the second legs of the extended filaments include the second bristles.

In some disclosed embodiments of the method, each extended filament is anchored asymmetrically to the brush head, thereby forming bristle pairs comprising the first and the second bristles.

In some disclosed embodiments of the method, the first height is about 0.300 inch (7.62 millimeters) to about 0.700 inch (17.78 millimeters). In these and other disclosed embodiments of the method, the second height is about 0.500 inch (12.70 millimeters) to about 1.000 inch (25.40 millimeters). In these and other disclosed embodiments of the method, the difference between the first height and the second height is about 0.100 inch (2.54 millimeters) to about 0.400 inch (10.16 millimeters).

In some disclosed embodiments of the method, the first height is about 0.100 inch (2.54 millimeters) to about 0.300 inch (17.78 millimeters). In these and other disclosed embodiments of the method, the second height is about 0.375 inch (9.525 millimeters) to about 0.500 inch (12.70 millimeters). In these and other disclosed embodiments of the method, the difference between the first height and the second height is about 0.100 inch (2.54 millimeters) to about 0.400 inch (10.16 millimeters).

In some disclosed embodiments of the method, the diameter of the first and second bristles is between about 0.002 inch (0.051 millimeters) and 0.005 inch (0.127 millimeters). Some disclosed embodiments of the method oscillate the brush at frequencies between about 40-350 Hz. Other disclosed embodiments of the method oscillate the brush at frequencies between about 90-175 Hz. Yet other embodiments of the method oscillate the brush at frequencies between about 90-115 Hz.

Some disclosed embodiments of the method oscillate the brush within a range of about 3-30 degrees. Other disclosed embodiments of the method oscillate the brush within a range of about 3-15 degrees.

In accordance with another aspect of the present disclosure, a method is provided. The method includes oscillating, via a motorized drive system, a brush having a plurality of tufts each comprising a plurality of first bristles extending to a first height and a plurality of second bristles extending to a second, greater height, increasing the amplitude of the oscillating brush by loading the brush via one of contact between the first and second bristles and the skin of the subject and contact between the second bristles and the skin of the subject, and moving the oscillating brush over the skin of the subject.

Some disclosed embodiments of the method includes increasing the amplitude of the oscillating brush by loading the brush occurs from contact between the second bristles and the skin of the subject, and subsequently, from contact between first and second bristles and the skin of the subject.

Some disclosed embodiments of the method also include applying a cleansing agent to the skin or shaving cream or gel to hair of the subject, and increasing a lathering effect of the cleansing agent or shaving cream or gel via oscillation of the brush.

In some disclosed embodiments of the method, the increased lathering effect occurs contemporaneously with the increase in amplitude of the oscillating brush via contact between the first and second bristles and the skin and/or hair of the subject.

In accordance with aspects of the present disclosure, a brush is provided. The brush includes a brush head to which one or more tufts of bristles are secured. Each tuft comprises a plurality of first bristles that extend a first height from the brush head and a plurality of second bristles that extend a second height from the base. The first height in some embodiments is less than the second height.

In accordance with another aspect of the present disclosure, a powered skin brush is provided. The powered skin brush includes a powered handle having a motor assembly configured to output motion, a brush selectively mounted to the powered handle and including a brush head configured to be moved by the motion outputted by the motor assembly, and a plurality of tufts anchored to the brush head. In some embodiments, each tuft comprises a plurality of first bristles extending a first height from the brush head and a plurality of second bristles extending a second height from the base. The first height in some embodiments is less than the second height.

In accordance with still another aspect of the present disclosure, a brush is provided. The brush includes a brush head having a plurality of tuft receiving openings; and a plurality of extended filaments each asymmetrically anchored to one of the plurality of tuft receiving openings in order to form bristle pairs having first and second legs of different heights. The ends of the bristle pairs in some embodiments have shapes independently selected from the group consisting of flat, rounded, and tapered.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 is a perspective view of one example of a brush in accordance with aspects of the present disclosure;

FIG. 2 is a top view of a brush, such as the brush of FIG. 1;

FIG. 3 is a cross-sectional view of the brush of FIG. 1 adapted to be coupled to components of a drive motor system;

FIG. 4 is a perspective view of one example of a brush head in accordance with aspects of the present disclosure;

FIG. 5 is a partial schematic view of the brush head of FIG. 4, into which a tuft of bristles is anchored;

FIGS. 6-8 are examples of a single filament asymmetrically anchored into a brush head in accordance with aspects of the present disclosure, the anchored filament forming, for example, a bristle pair;

FIG. 9 is a perspective view of one example of a personal care appliance on which the brush of FIG. 1 is mounted;

FIG. 10 is a perspective view of the personal care appliance of FIG. 9 with the brush exploded therefrom;

FIG. 11 is a functional block diagram of several components of the personal care appliance of FIG. 9; and

FIG. 12 illustrates in graphical form the relationship between applied load and amplitude of one embodiment of the brush in a loaded condition.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

The following discussion provides examples of brushes suitable for use in applications such as skin care, including, for example, cleansing, exfoliating, shaving, etc.

The brushes include a brush head from which a plurality of tufts extend. In the examples disclosed herein, the tufts include bristles that extend from the brush head to different heights, and may include bristles of varying diameters from tuft to tuft or within each tuft. As will be described in more detail below, some examples of the brushes include filaments that are stapled, fused and end molded or otherwise anchored to the brush head asymetrically in order to define bristle pairs having a first, shorter bristle leg and a second, longer bristle leg.

It has been observed by the inventors of the disclosed subject matter that representative examples of the brushes described herein provide an increased foaming/lathering effect when employed to apply a cream or cleansing agent to a surface, such as a subject's skin or facial hair. In particular, it has been observed that increased foaming/lathering occurs in representative examples of the brush near the convergence of the first, shorter bristle and a second, longer bristle of each bristle pair. The examples of the brushes described herein also provide multiple uptakes, i.e., a dynamic change to the resonant system resulting in a perceivable amplitude increase in response to additional loading of the brush, when the brush is oscillated against the skin, facial hair, etc., at sonic frequencies. Other benefits can be realized by the brushes of the present disclosure, including, for example, a softer feel, sometimes characterized as “luxurious” to the subject.

While the various aspects of the present disclosure are presented with examples related to skin care, it will be appreciated that the disclosed examples are illustrative in nature, and therefore, should not be construed as limited to skin care applications. It should therefore be apparent that these various aspects of the present disclosure have wide application, and can be employed with any tufted bristle brush, including but not limited to toothbrushes, paint brushes, scrub brushes, etc.

In the following description, numerous specific details are set forth in order to provide a thorough understanding of one or more embodiments of the present disclosure.

It will be apparent to one skilled in the art, however, that many embodiments of the present disclosure may be practiced without some or all of the specific details. In some instances, well-known process steps have not been described in detail in order to not unnecessarily obscure various aspects of the present disclosure. Further, it will be appreciated that embodiments of the present disclosure may employ any combination of features described herein.

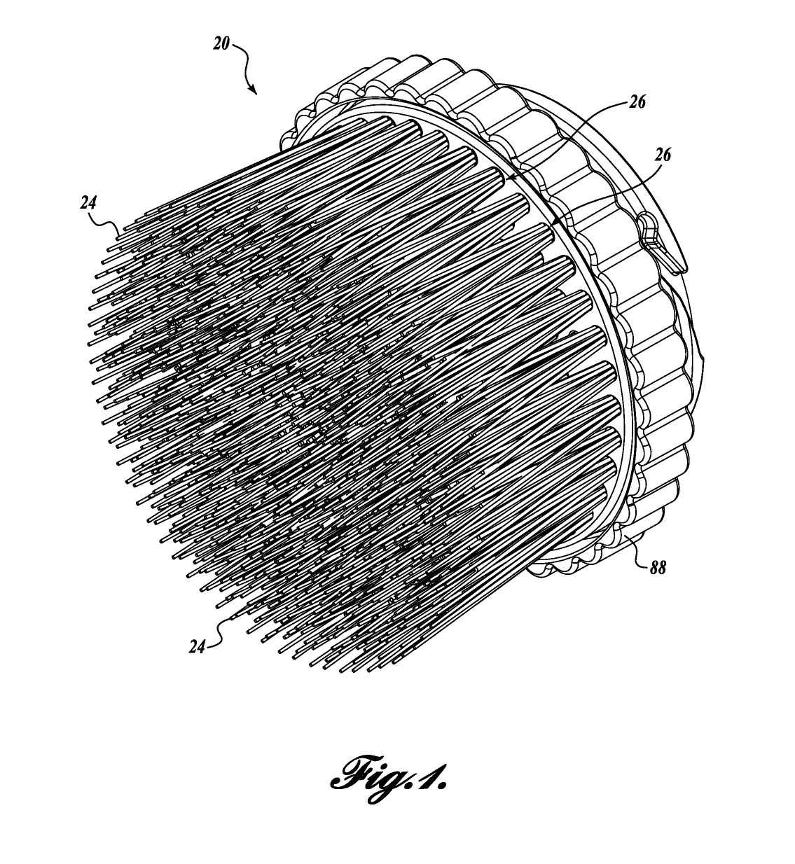

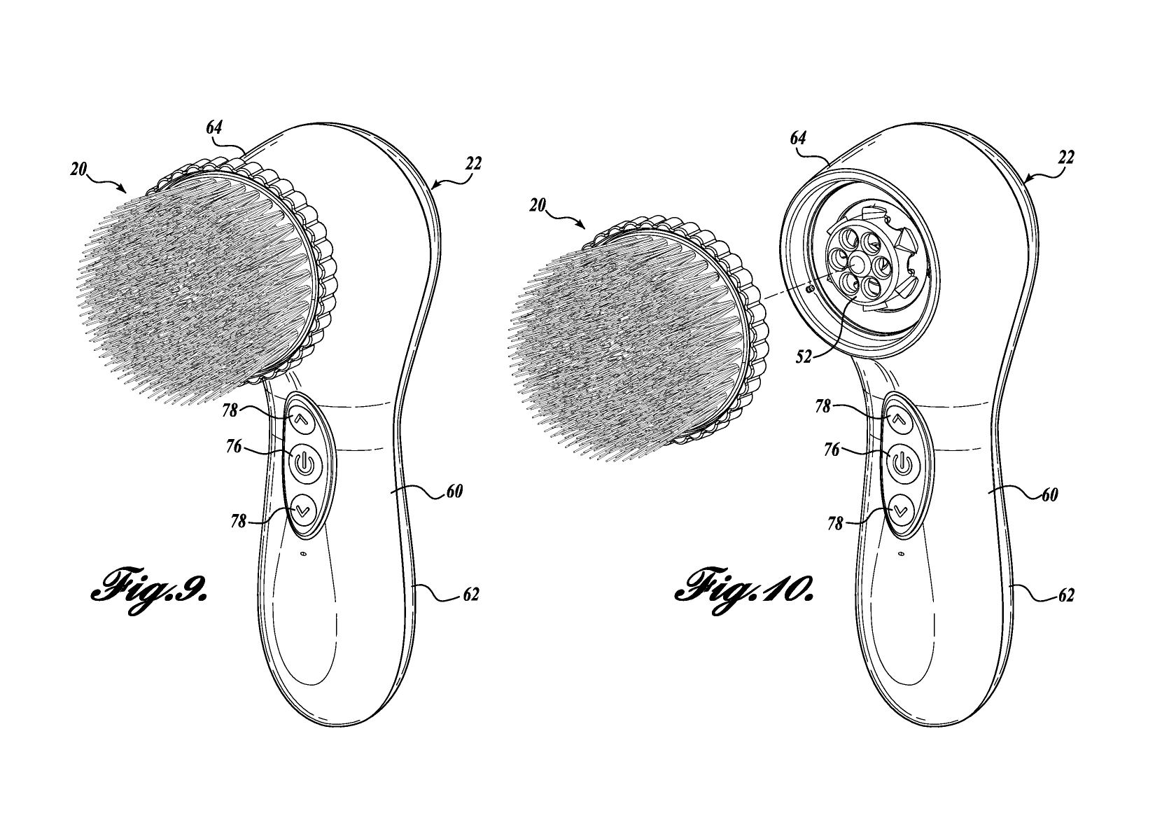

Turning now to FIG. 1, there is shown one example of a brush, generally designated 20, formed in accordance with aspects of the present disclosure. The brush 20 includes a plurality of bristles 24 arranged in one or more tufts 26. In the embodiment shown in FIG. 1, the bristles 24 of each tuft 26 have different bristle heights. The brush 20 shown in the example of FIG. 1 is suitable for use with a personal care appliance, such as personal care appliance 28 (See FIG. 9). In one suitable use, the brush 20 can be rotated or oscillated over a patient's skin by the personal care appliance in order for the bristles of the tufts to clean, massage, exfoliate, apply a cleansing or shaving cream or gel to, etc., a subject's skin or body hair.

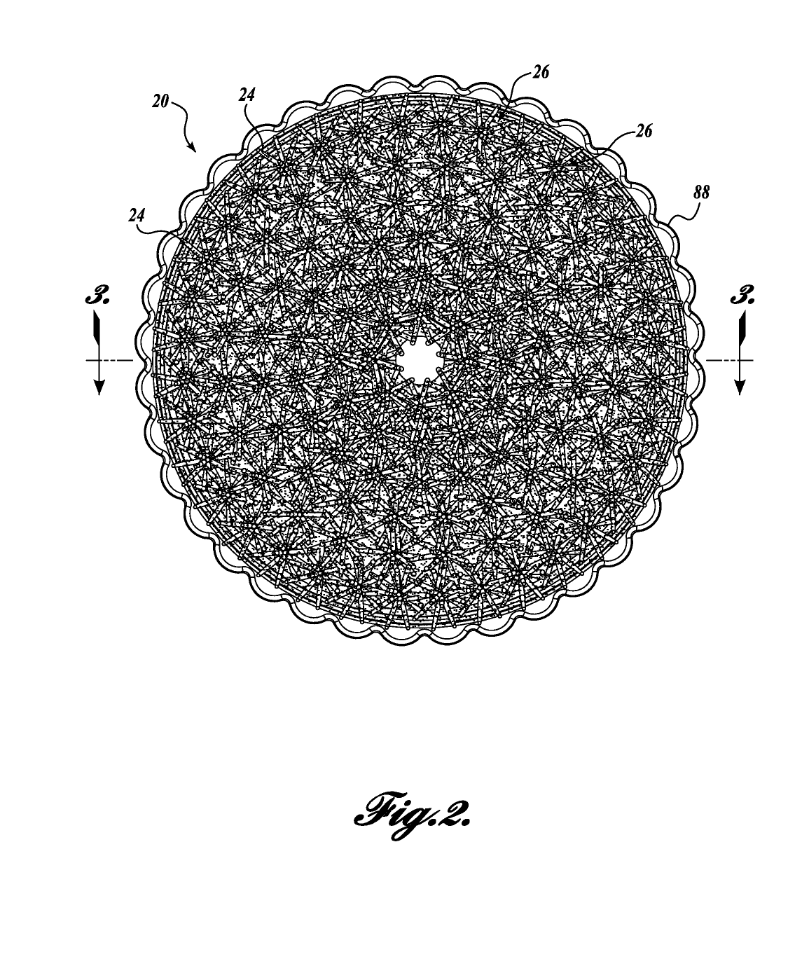

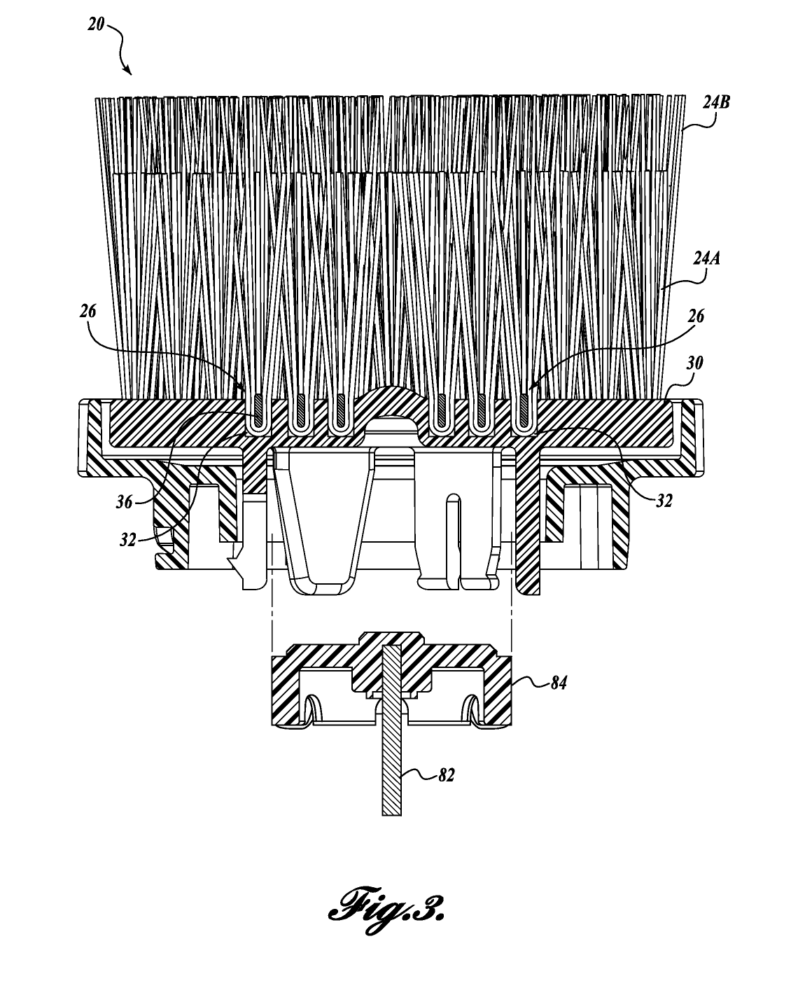

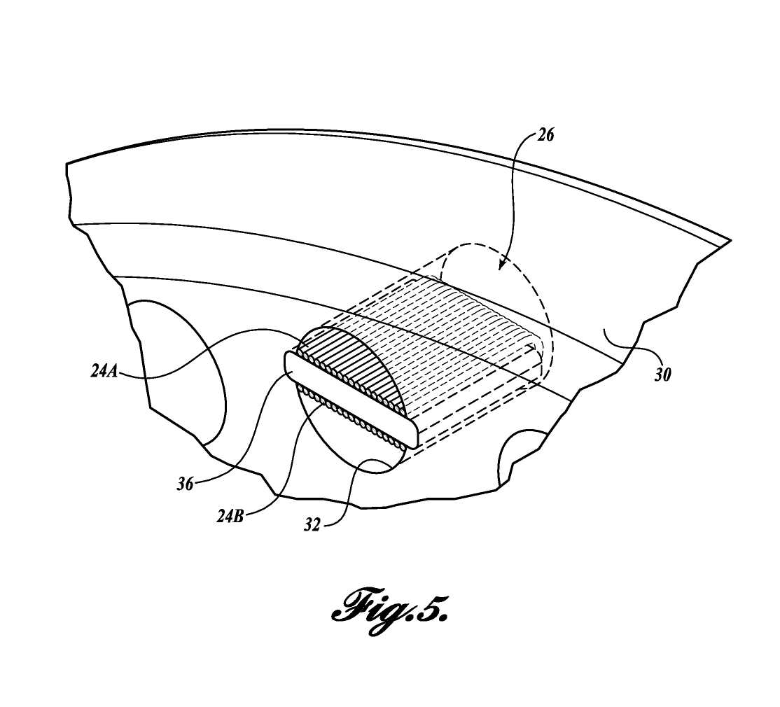

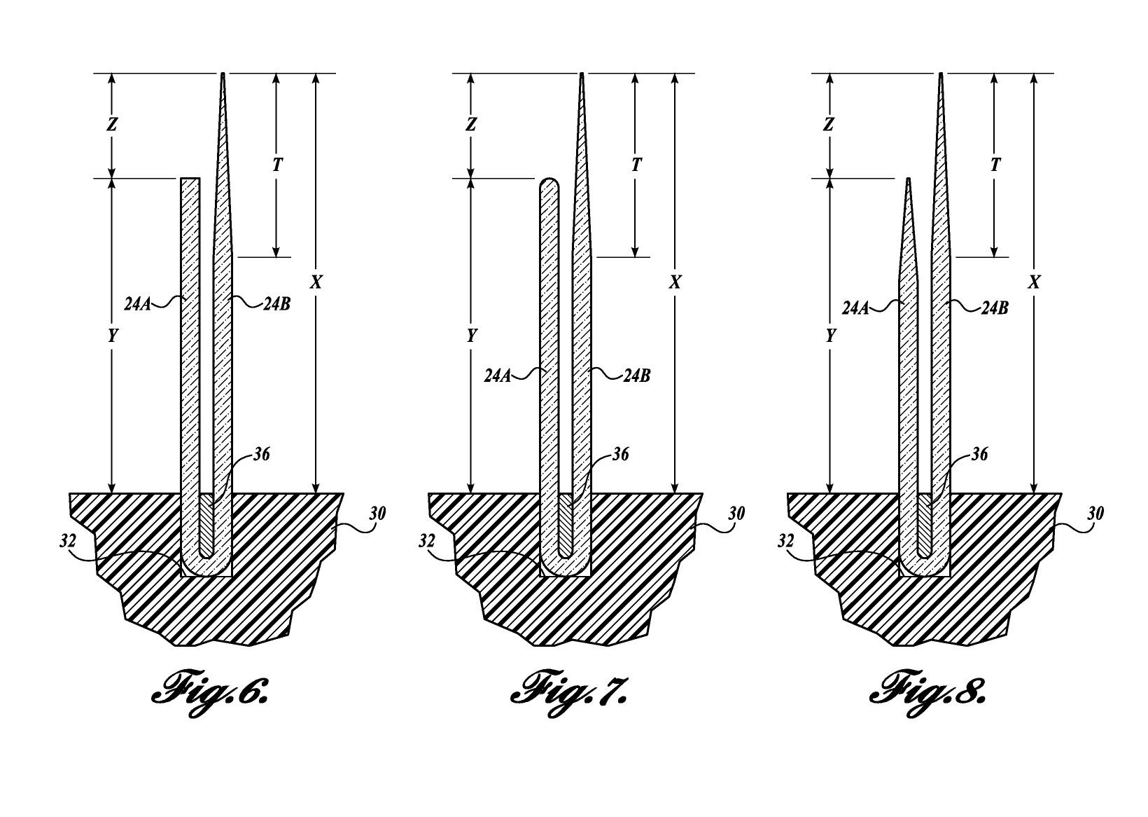

Turning now to FIGS. 2-5, one example of the brush 20 will be described in more detail. As best shown in FIGS. 3 and 4, the brush 20 includes a brush head 30 configured with one or more tuft receiving openings 32, such as holes, recesses, etc. The number, size and/or location of the tuft receiving openings 32 can vary between embodiments of the present disclosure depending, in part, upon its intended application. In the embodiment shown in FIG. 4, the brush head 30 has a generally circular lateral cross section, although other geometrical cross-sections (i.e., triangular, elliptical, lobular, square, etc.) may be employed, especially in embodiments that employ oscillating motion devices. The brush head 30 can be constructed out of plastic, such as nylon, polypropylene, polyurethane, polyethylene, etc., although other materials may be utilized, including lightweight metals, such as aluminum, titanium, etc. The brush 20 also includes a plurality of tufts 26 anchored into the tuft receiving openings 32. The tufts may be anchored via staples, anchor wires, etc., or by other techniques such as being fused and end molded, among others. The tufts 26 are spaced apart from one another and include a plurality (e.g., 10-200 or more) of bristles 24. The bristles 24 extend upwardly from the brush head and include a number of bristles 24A having a first, shorter height, denoted as Y in FIGS. 6-8. Also included are a number of bristles 24B having a second, longer height, denoted as X in FIGS. 6-8.

The bristles 24A of each tuft 26 in some embodiments have a height of about 0.300 inch (7.62 millimeters) to about 0.700 inch (17.78 millimeters) or greater and the bristles 24B of each tuft 26 in some embodiments have a height of about 0.500 inch (12.70 millimeters) to about 1.000 inch (25.40 millimeters) or greater. In other embodiments, the bristles 24A of each tuft 26 in some embodiments have a height of about 0.100 inch (2.54 millimeters) to about 0.300 inch (7.62 millimeters) or greater and the bristles 24B of each tuft 26 in some embodiments have a height of about 0.375 inch (9.525 millimeters) to about 0.500 inch (12.70 millimeters) or greater. In some embodiments, the difference in heights between the bristles 24A and bristles 24B, denoted as Z in FIGS. 6-8, is in the range of approximately 0.100 inch (2.54 millimeters) to about 0.400 inch (10.16 millimeters) or greater. The diameter of the bristles 24A and 24B in some embodiments are in the range of approximately 0.002 inch (0.051 millimeter) to 0.006 inch (0.152 millimeter), and can vary within each tuft and/or from tuft to tuft. In some embodiments, the Y:X ratio is between approximately 0.60 and approximately 0.80, and in other embodiments, the Y:X ratio is between approximately 0.66 and approximately 0.75. In yet other embodiments, such as, for example, a shaving brush, the Y:X ratio is between approximately 0.20 and approximately 0.60. In one representative embodiment, the diameter of the first and second bristles is 0.003 inch (0.0762 millimeters), the height of the first bristle is 0.500 inch (12.70 millimeters), and the height of the second bristles is 0.800 inch (20.32 millimeters). The bristles 24 can be constructed out of a variety of materials, such as polymers and co-polymers. In some embodiments, the bristles 24 may be constructed out of polybutylene terephthalate (PBT), such as DuPont™ Crastin®, polyethylene terephthalate (PET), such as DuPont™ Rynite®, nylons of differing blends, such as DuPont™ Zytrel®, polyester, such as DuPont™ Hytrel®, a thermoplastic elastomer (TPE), coextruded elastomers, polypropylene, polyethylene, such as DuPont™ Bynel®, combinations or blends thereof, etc. In some embodiments, the filaments may have cross sections including but not limited to circular, diamond, hollow, rectangular, X-shape, multi-lobed, etc. The bristles may be treated with anti-microbial agents in some embodiments or coated or compounded with an anti-microbial material, such as silver zeolites, zinc, copper, etc., or other organic additives. End finishing of the bristles can also be selectively varied, some of which may be smooth polished end rounding, flat, tapered, raw cut, split, domed, semi-domed, etc. In some embodiments, one or more of the bristles may be flagged or multi-tipped.

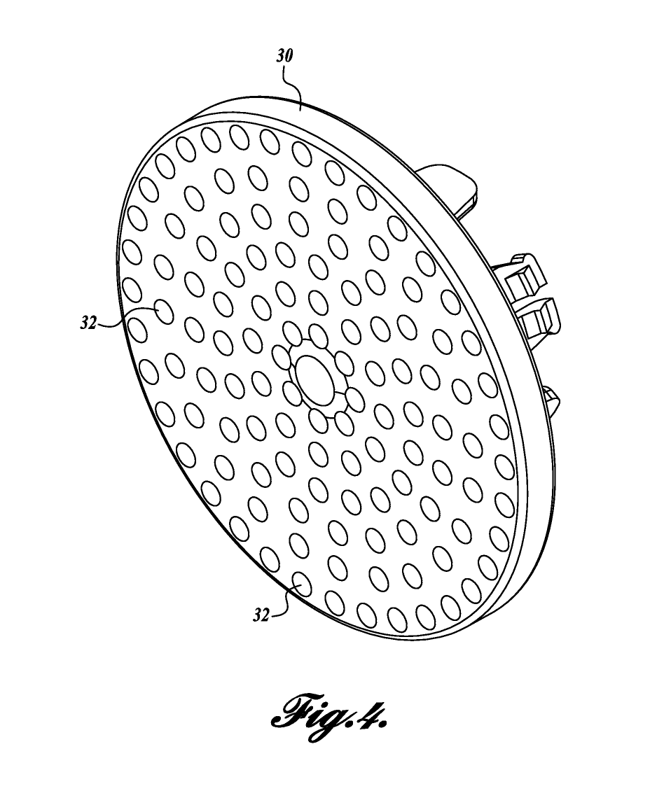

In accordance with an aspect of the present disclosure, the bristles 24 can be configured and arranged as bristle pairs 24A and 24B, as shown in FIGS. 5-6. In that regard, in some embodiments, each bristle pair 24A and 24B is formed by a single filament asymmetrically anchored to the brush head 30. For example, each bristle pair 24A and 24B can be formed by a single filament folded around a staple, anchor wire, or other anchoring device 36. Together with at least one anchoring device 36, the plurality of filaments are driven into the tuft receiving opening 32, thereby forming a tuft 26 with a plurality of bristle pairs 24A and 24B. For example, as shown in FIGS. 3 and 5, a plurality of filaments are wrapped or looped around a staple or other anchoring device 36 into a generally J-shaped configuration having a pair of bristle legs. The folded filaments and the anchoring device 36 are then together driven by a mandrel or similar device into the tuft receiving opening 32 to press the bight portion of the tuft toward the base of the tuft receiving opening 32. Because the staple or anchoring device 36 is slightly longer than the diameter of the tuft receiving opening 32, the staple or anchoring device 36 is pressed into the material of the brush head 30, and the tuft 26 and staple or anchoring device 36 are thus firmly secured to the brush head 30. In other embodiments, the tufts 26 may include fused and end molded bristles.

FIGS. 6-8 illustrate several examples of bristle pairs 24A and 24B formed by a single filament anchored to the brush head 30 via an anchoring device 36 such as an anchoring wire, staple, etc. As shown in the embodiments of FIGS. 6-8, the ends of bristles 24B can have a tapered shape while the ends of the bristles 24A include a flat shape, a rounded shape, and a tapered shape, respectively. It will be appreciated that the angle formed by the tapered end may vary, depending on its intended application. In some embodiments, the taper extends between approximately 0.300 inch (7.62 millimeters) and 0.500 inch (12.70 millimeters), and is denoted as T in FIGS. 6-8. In other embodiments, the taper may extend between approximately 0.200 inch (5.08 millimeters) and 0.400 inch (10.16 millimeters). The taper may occur on one or more sides of the bristle or may occur on all sides of the bristle, thereby forming either a conical, pyramidal, etc., bristle end or a frustoconical, frusto-pyramidal, etc., bristle end depending, in part, on the cross-sectional shape of the bristle and the desired bristle tip shape. In some embodiments, the distance T is approximately 0.450 inch (11.43 millimeters) +/−0.010 inch (0.254 millimeter), and the diameter of the bristle tip is approximately 0.002 inch (0.051 millimeter) or less. It should also be recognized that the degree of end rounding can be varied in embodiments of the present disclosure.

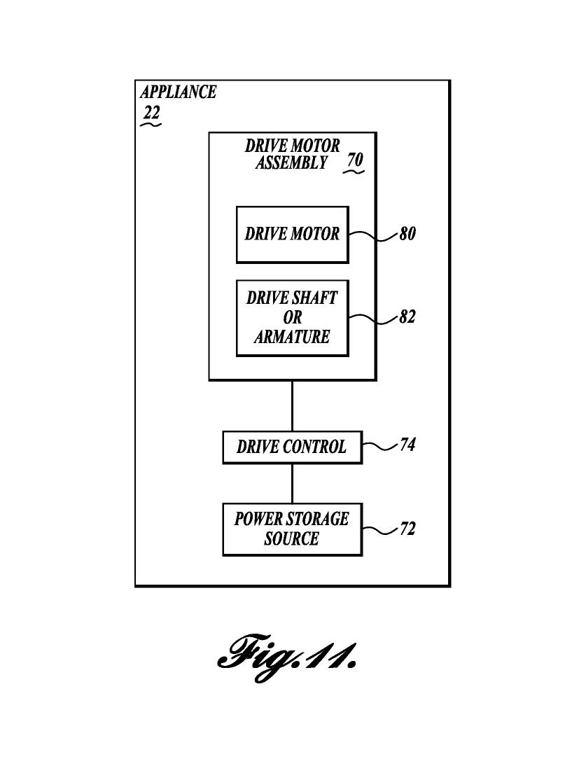

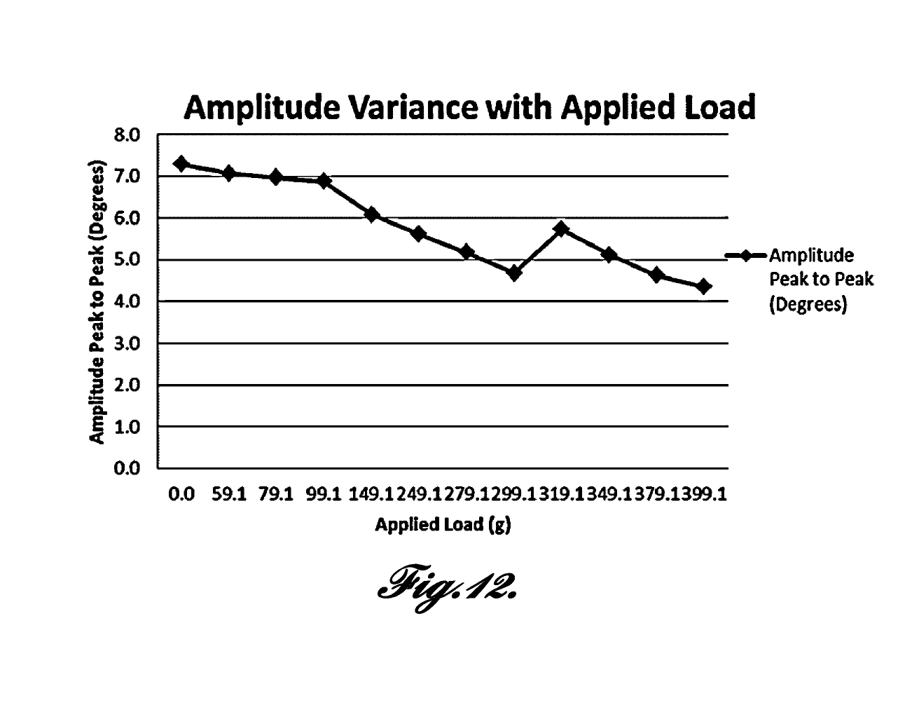

As briefly stated above, some examples of the brush 20 are suitable for use with a personal care appliance, such as the personal care appliance 22 of FIGS. 9-11. As best shown in FIGS. 9 and 10, there is shown one example of the personal care appliance 22. The appliance 22 includes a body 60 having a handle portion 62 and a head attachment portion 64. The head attachment portion 64 is configured to selectively attach a head, such as brush head 20, to the appliance 22. The appliance body 60 houses the operating structure of the appliance. As shown in block diagrammatic form in FIG. 11, the operating structure in one embodiment includes a drive motor assembly 70, a power storage source 72, such as a rechargeable battery, and a drive control 74 that includes an on/off button 76 (See FIG. 9) configured and arranged to selectively deliver power from the power storage source 72 to the drive motor assembly 70. In some embodiments, the drive control 74 may also include a power adjust or mode control buttons 78 (See FIG. 9) coupled to control circuitry, such as a programmed microcontroller or processor, which is configured to control the delivery of power to the drive motor assembly 70. The drive motor assembly 70 in some embodiments includes an electric drive motor 80 that drives an attached head, such as brush head 20, via a drive shaft or armature 82.

The drive motor assembly 70 is configured to impart motion to the brush head 20. The drive motor assembly 70 in some embodiments may be configured to operate the brush head 20 at sonic frequencies, typically in the range of about 40-350 Hz, oscillating the brush head 20 back and forth within a range or amplitude of about 3-30 degrees, or greater. One example of a drive motor assembly 70 that may be employed by the appliance 22 to oscillate the brush head 20 is shown and described in U.S. Pat. No. 7,786,626, the disclosure of which is hereby incorporated by reference in its entirety. However, it should be understood that this is merely an example of the structure and operation of one such appliance and that the structure, operation frequency and oscillation amplitude of such an appliance could be varied, depending in part on its intended application and/or characteristics of the brush head, such as its inertial properties, etc.

In some embodiments, the brush 20 includes fixed outer retainer 88, as shown in FIGS. 1 and 3. In some embodiments, the fixed outer retainer 88 may include one or more spaced apart tufts (not shown). The brush head 30 and the outer retainer 88 together include an attachment system configured to provide selective attachment of the brush 20 to the head attachment portion 64 of the personal care appliance 22. When attached to the personal care appliance 22 by the attachment system, the following occurs: (1) the brush head 30 is operatively connected to the drive motor assembly 70, for example, via a drive hub 84, in a manner that provides oscillating motion thereto; and (2) the outer retainer 88 fixedly secures the brush 20 to the head attachment portion 64 of the appliance 22. Accordingly, the attachment system in some embodiments provides a quick and easy technique for attaching and detaching the brush 20 to the personal care appliance 22. It will be appreciated that the attachment system also allows for other brushes to be attached to the appliance, and allows for a replacement brush 20 to be attached to the appliance, when desired. One attachment system that may be practiced with embodiments of the present disclosure is set forth in U.S. Pat. No. 7,386,906, the disclosure of which is hereby incorporated by reference in its entirety. It will be appreciated that other attachment systems can be employed to provide either tooled or tool-less techniques for selectively attaching the brush 20 to a personal care appliance, such as appliance 22, in a manner that (1) provides oscillating motion to the brush head 30; and (2) maintains the connection between the brush head 30 and the drive motor assembly 70. For example, in some embodiments, the brush head 30 includes a coupling interface configured to cooperatingly connect to an oscillating drive shaft of an associated drive motor assembly 70 in a manner that transmits oscillating motion to the brush head 30 while fixedly securing the brush head 30 thereto. As such, it should be understood that while the retainer 88 may provide certain benefits to some embodiments of the brush head 20, it is optional, and thus it may be omitted, if desired.

The above-described examples of the brush 20 can be used in some embodiments to clean, massage, exfoliate, etc., a subject's skin. In other embodiments, the above-described examples of the brush 20 can be used to apply shaving cream, gel, soap, etc., to the subject's skin or to body hair associated with the subject's skin. In that regard, any of the brush heads herein disclosed can be, for example, attached to a powered or non-powered appliance for assisting the subject to move the brush 20 over the subject's skin. In some embodiments that employ the person care appliance 22, the personal care appliance 22 is then turned on and the attached brush head is operated at sonic frequencies in the range of about 40-350 Hz, and in some embodiments between 90-175 Hz or between 90-115 Hz, oscillating the brush head back and forth within a range of about 3-30 degrees or greater in some embodiments and within a range of about 3-15 degrees in other embodiments. In some embodiments, the brush 20 is oscillated near (i.e., slightly, e.g., within 5-10 Hz) of its resonant frequency.

Once oscillating in these and other embodiments, the brush 20 is applied against the skin and/or hair on the body, such as on the face. In that regard, as the second, longer bristles 24B contact the skin and/or hair, the bristles 24B become loaded, whereby a dynamic change to the resonant system occurs resulting in a perceivable amplitude increase in response to additional loading of the brush. This occurrence in resonant systems is generally referred to as “uptake.” Thus, the first uptake occurs when the brush first engages the skin and force or load is applied. FIG. 12 illustrates the relationship between applied load and amplitude of one embodiment of the brush in a loaded condition. The first uptake occurs around the left most point in FIG. 12.

The oscillating brush 20 can continue to be traversed over sections of the subject's skin and/or hair. Because of the configuration of the brushes described herein, when additional pressure or load is applied, enough to bend the second, longer bristles 24B in some embodiments, the second, shorter bristles 24A begin to engage the subject's skin and/or hair. Again, as a result, the bristles 24A become loaded, and similar to the bristles 24B described above, a second uptake occurs, providing a unique feeling to the subject. The second uptake can be seen in Graph 1 by the spike in amplitude towards the right side of FIG. 12.

Once the skin and/or hair is treated to the desired amount, the brush 20 can be removed therefrom and the appliance 22 can be powered down. Alternatively, the appliance 22 can be powered down automatically via a programmed operation.

The methods described above can be carried out with or without the use of skin care formulas, cleansing agents, shaving soaps, creams or gels. However, any preparation of the skin area prior to treatment can be employed as part of the methods disclosed above. With the use of cleansing agents, shaving creams, gels, etc., and the like, the movement of the bristles 24 has been observed to promote an improved lathering effect over heretofore known brushes. In some embodiments, the improvement in foam generation/lathering coincides contemporaneously with the second uptake. Moreover, the bristle end treatment in some embodiments described herein provides a soft feel to the subject's skin, and has been characterized by subjects as “luxurious.” Other benefits may be realized by examples of the present disclosure. For example, the bristles 24A and 24B can be tuned to resonate at different frequencies.

It should be noted that for purposes of this disclosure, terminology such as “upper,” “lower,” “vertical,” “horizontal,” “inwardly,” “outwardly,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” “secured,” “mounted” and variations thereof herein are used broadly and encompass direct and indirect connections, couplings, securements and mountings.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A method of treating skin of a subject with a handheld appliance, comprising:
oscillating, via a motorized drive system of the handheld appliance, a brush having a plurality of tufts, each tuft comprising a plurality of first bristles extending to a first height and a plurality of second bristles extending to a second, greater height;
moving the brush into contact with the skin of the subject; and thereafter
moving the oscillating brush over the skin of the subject.

2. The method of claim 1, further comprising
increasing the amplitude of the oscillating brush by loading the brush via one of contact between the first and second bristles and the skin of the subject and contact between the second bristles and the skin of the subject.

3. The method of claim 1, wherein the second bristles include tapered ends and the first bristles have end configurations selected from the group consisting of flat, rounded, domed, semi-domed, split, multi-tipped, and tapered.

4. The method of claim 1, wherein each tuft comprises a plurality of extended filaments each including a first leg and a second leg, wherein the first legs of the extended filaments include the first bristles and the second legs of the extended filaments include the second bristles.

5. The method of claim 4, wherein each extended filament is anchored asymmetrically to the brush head, thereby forming bristle pairs comprising the first and the second bristles.

6. The method of claim 1, wherein the first height is about 0.300 inch (7.62 millimeters) to about 0.700 inch (17.78 millimeters).

7. The method of claims 1, wherein the first height is about 0.100 inch (2.54 millimeters) to about 0.300 inch (17.78 millimeters).

8. The method of claim 1, wherein the second height is about 0.500 inch (12.70 millimeters) to about 1.000 inch (25.40 millimeters).

9. The method of claim 1, wherein the second height is about 0.375 inch (9.525 millimeters) to about 0.500 inch (12.70 millimeters).

10. The method of claim 1, wherein the difference between the first height and the second height is about 0.100 inch (2.54 millimeters) to about 0.400 inch (10.16 millimeters).

11. The method of claim 9, wherein the diameter of the first and second bristles is between about 0.002 inch (0.051 millimeters) and 0.005 inch (0.127 millimeters).

12. The method of claim 1, wherein oscillating the brush includes oscillating the brush at a frequency between one of about 40-350 Hz, about 90-175 Hz, and about 90-115 Hz.

13. The method of claim 12, wherein oscillating the brush includes oscillating the brush within an amplitude range of one of about 3-30 degrees and about 3-15 degrees.

14. The method of claim 1, wherein oscillating the brush includes oscillating the brush at a frequency between about 90-115 Hz and within an amplitude of about 3-15 degrees.

15. A method of treating skin of a subject, comprising:
oscillating, via a motorized drive system, a brush having a plurality of tufts each comprising a plurality of first bristles extending to a first height and a plurality of second bristles extending to a second, greater height; and
increasing the amplitude of the oscillating brush by loading the brush via one of contact between the first and second bristles and the skin of the subject and contact between the second bristles and the skin of the subject; and
moving the oscillating brush over the skin of the subject.

16. The method of claim 15, wherein the diameter of the first and second bristles is 0.003 inch (0.0762 millimeters), the height of the first bristle is 0.500 inch (12.70 millimeters), and the height of the second bristles is 0.800 inch (20.32 millimeters).

17. The method of claims 15, wherein said increasing the amplitude of the oscillating brush by loading the brush occurs from contact between the second bristles and the skin of the subject.

18. The method of claim 15, wherein said increasing the amplitude of the oscillating brush by loading the brush occurs from contact between the second bristles and the skin of the subject, and subsequently, from contact between first and second bristles and the skin of the subject.

19. The method of claim 18, further comprising applying a lathering agent to the skin or hair of the subject; and
increasing a lathering effect of the lathering agent via oscillation of the brush.

20. The method of claim 19, wherein the increased lathering effect occurs contemporaneously with the increase in amplitude of the oscillating brush via contact between the first and second bristles and the skin and/or hair of the subject.
